(19) United States
(12) Patent Application Publication
(10) Pub. No.: US 2023/0249889 A1
(43) Pub. Date: Aug. 10, 2023

(54) FOLDED 3D SHAPED PACKAGING PRODUCT FROM AN AIR-LAID BLANK

(71) Applicant: Stora Enso OYJ, Helsinki (FI)

(72) Inventors: Maria Törnblom, Halmstad (SE); Martin Malmqvist, Halmstad (SE)

(73) Assignee: Stora Enso OYJ, Helsinki (FI)

(21) Appl. No.: 18/004,501

(22) PCT Filed: Jul. 8, 2021
(86) PCT No.: PCT/IB2021/056121

§ 371 Date: Jan. 6, 2023

(30) Foreign Application Priority Data
Jul. 9, 2020 (SE) 2050874-3
Jul. 14, 2020 (SE) 2050889-1

(51) Int. Cl. B65D 81/02; B65D 81/38; D04H 1/732; D04H 1/58; D04H 1/425; D04H 1/541; B31B 50/44

(52) U.S. Cl. CPC B65D 81/022; B65D 81/3813; D04H 1/732; D04H 1/58; D04H 1/425; D04H 1/5412; B31B 50/44; B32B 3/30

(57) ABSTRACT

A folded 3D shaped packaging product (30) is folded at at least one crease (22A, 22B, 22C, 22D, 22E) constituting a folding line in a 3D shaped product (20) formed by hot pressing of an air-laid blank (10) comprising natural fibers at a concentration of at least 70% by weight of the air-laid blank (10) and a thermoplastic polymer binder at a concentration selected within an interval of from 4 up to 30% by weight of the air-laid blank (10). The folded 3D shaped packaging product (30) is useful for cushioning and/or thermal insulation of packaged goods and can protect multiple sides of the packaged goods.

### TECHNICAL FIELD

The present embodiments generally relate to three dimensional (3D) shaped packaging products, and in particular to folded 3D shaped packaging products for cushioning and/or thermal insulation of packaged goods.

### BACKGROUND

With growing awareness for the environment and humanly induced climate change, the use of single use plastic items and products has come more and more into question. However, despite this concern the use of these items and products has grown vastly with new trends in lifestyles and consumer habits of the last decade. One reason for this is that more and more goods are transported around the globe and these goods need protection against impact or shock and/or extreme temperatures. A common way of protecting the goods is to include cushioning and/or insulating elements or products, such as inserts of suitable form into the packaging. These can be made from different materials but are typically made from a foamed polymer, of which expanded polystyrene (EPS) is by far cheapest and most common. In some cases, the entire packaging can be made out of EPS. One example is transport boxes for food that have to be kept within specified temperature intervals, such as cold food, e.g., fish, or hot food, e.g., ready meals. EPS is, however, one of the most questioned plastic materials and many brand owners are looking for more sustainable solutions for these packaging applications. Many countries have also begun to take legislative actions against single use plastic items and products, which increases the pressure to find alternative solutions.

More sustainable alternatives to polymer products exist today, such as inserts made by a process known as pulp molding, where a fiber suspension is sucked against a wire mold by vacuum. Another technique for forming such inserts are described in U.S. patent application no. 2010/0190020, European patent no. 1 446 286 and International application no. 2014/142714, which concern hot pressing of porous fiber mats produced by the process called air-laying into 3D structures with matched rigid molds or by membrane molding.

There is still a need for improved 3D shaped packaging products, and in particular such 3D shaped packaging products that can be folded around packaging goods to be protected from shock impact and/or to be terminally insulated.

### SUMMARY

It is an objective to provide folded 3D shaped packaging products for cushioning and/or thermal insulation of packaged goods.

It is a particular objective to provide such folded 3D shaped packaging products that can be manufactured from natural fibers.

These and other objectives are met by embodiments of the present invention.

The present invention is defined in the independent claims. Further embodiments of the invention are defined in the dependent claims.

An aspect of the invention relates to an air-laid blank comprising natural fibers at a concentration of at least 70% by weight of the air-laid blank and a thermoplastic polymer binder at a concentration selected within an interval of from 4 up to 30% by weight of the air-laid blank. The air-laid blank comprises at least one crease constituting a folding line for folding a 3D shaped product into a folded 3D shaped packaging product for cushioning and/or thermal insulation of packaged goods. The 3D shaped product is formed by hot pressing of the air-laid blank comprising the at least one crease. Alternatively, the at least one crease constitutes a folding line for hot pressing and folding the air-laid blank to form the folded 3D shaped packaging product for cushioning and/or thermal insulation of packaged goods.

Another aspect of the invention relates to a method for manufacturing an air-laid blank comprising natural fibers at a concentration of at least 70% by weight of the air-laid blank and a thermoplastic polymer binder at a concentration selected within an interval of from 4 up to 30% by weight of the air-laid blank.

The method comprises pressing a die with at least one bar into the air-laid blank to form at least one crease constituting a folding line for folding a 3D shaped product into a folded 3D shaped packaging product for cushioning and/or thermal insulation of packaged goods. The 3D shaped product is formed by hot pressing of the air-laid blank comprising the at least one crease. Alternatively, the at least one crease constitutes a folding line for hot pressing and folding the air-laid blank comprising the at least one crease to form the folded 3D shaped packaging product for cushioning and/or thermal insulation of packaged goods.

A further aspect of the invention relates to a method for manufacturing an air-laid blank comprising natural fibers at a concentration of at least 70% by weight of the air-laid blank and a thermoplastic polymer binder at a concentration selected within an interval of from 4 up to 30% by weight of the air-laid blank. The method comprises sawing or cutting at least one crease in the air-laid blank. The at least one crease constituting a folding line for folding a 3D shaped product into a folded 3D shaped packaging product for cushioning and/or thermal insulation of packaged goods. The 3D shaped product is formed by hot pressing of the air-laid blank comprising the at least one crease. Alternatively, the at least one crease constitutes a folding line for hot pressing and folding the air-laid blank comprising the at least one crease to form the folded 3D shaped packaging product for cushioning and/or thermal insulation of packaged goods.

Yet another aspect of the invention relates to a method for manufacturing a folded 3D shaped packaging product. The method comprises manufacturing an air-laid blank according to above. The method also comprises hot pressing of a male tool into the air-laid blank comprising at least one crease to form a 3D shaped product comprising at least one crease and having a 3D shape at least partly defined by the male tool and folding the 3D shaped product at the at least one crease to form the folded 3D shaped packaging product for cushioning and/or thermal insulation of packaged goods. Alternatively, the method comprises hot pressing of a male tool into the air-laid blank comprising at least one crease and positioned on a female tool folding the air-laid blank at the at least one crease to form the folded 3D shaped packaging product for cushioning and/or thermal insulation of packaged goods, wherein the folded 3D shaped packaging product having a 3D shape at least partly defined by the male tool and the female tool.

Another aspect of the invention relates to a folded 3D shaped packaging product for cushioning and/or thermal insulation of packaged goods. The folded 3D shaped packaging product is folded at at least one crease constituting a folding line in a 3D shaped product formed by hot pressing of an air-laid blank comprising natural fibers at a concentration of at least 70% by weight of the air-laid blank and a thermoplastic polymer binder at a concentration selected within an interval of from 4 up to 30% by weight of the air-laid blank.

A further aspect of the invention relates to a 3D shaped product. The 3D shaped product is formed by hot pressing of an air-laid blank comprising natural fibers at a concentration of at least 70% by weight of the air-laid blank and a thermoplastic polymer binder at a concentration selected within an interval of from 4 up to 30% by weight of the air-laid blank. The 3D shaped product comprises at least one crease constituting a folding line for folding the 3D shaped product into a folded 3D shaped packaging product for cushioning and/or thermal insulation of packaged goods.

Yet another aspect of the invention relates to a method for manufacturing a 3D shaped product. The method comprises hot pressing of a male tool into an air-laid blank comprising natural fibers at a concentration of at least 70% by weight of the air-laid blank and a thermoplastic polymer binder at a concentration selected within an interval of from 4 up to 30% by weight of the air-laid blank to form the 3D shaped product having a 3D shape at least partly defined by the male tool. The method also comprises pressing, simultaneously with hot pressing of the male tool, at least one bar into the air-laid blank to form at last one crease constituting a folding line for folding the 3D shaped product into a folded 3D shaped packaging product for cushioning and/or thermal insulation of packaged goods.

The present invention relates to folded 3D shaped packaging products that are highly suitable for cushioning of packaged goods providing excellent shock absorbing and damping properties. The folded 3D shaped packaging products also have thermally insulating properties and can therefore be used for storage and/or transport of tempered, such as cold or hot, goods, such as provisions and foodstuff. The folded 3D shaped packaging products suitable for cushioning and/or thermal protection are additionally made of environmentally friendly natural fibers in clear contrast to prior art foamed inserts made of polystyrene and other polymers.

### BRIEF DESCRIPTION OF THE DRAWINGS

The embodiments, together with further objects and advantages thereof, may best be understood by making reference to the following description taken together with the accompanying drawings, in which:

FIG. 1 is an illustrative embodiment of a die that can be used for manufacturing an air-laid blank with at least one crease prior to pressing into the air-laid blank;

FIG. 2 is an illustrative embodiment of the die in FIG. 1 pressed into the air-laid blank;

FIG. 3 is an illustrative embodiment of another die that can be used for manufacturing an air-laid blank with at least one crease with simultaneous cutting prior to pressing into the air-laid blank;

FIG. 4 is an illustrative embodiment of the die in FIG. 3 pressed into the air-laid blank;

FIGS. 5 and 6 schematically illustrate folding of an air-laid blank at creases;

FIG. 7 is a cross-sectional view of an illustrative embodiment of a folded 3D shaped packaging product;

FIG. 8 is an illustrative embodiment of a male tool and female tool that can be used to produce a folded 3D shaped packaging product prior to hot pressing the male tool into the air-laid blank;

FIG. 9 is an illustrative embodiment of the male tool and female tool in FIG. 8 with the male tool hot pressed into the air-laid blank;

FIG. 10 is an illustrative embodiment of a male tool that can be used to produce a 3D shaped product prior to hot pressing the male tool into the air-laid blank;

FIG. 11 is an illustrative embodiment of the male tool in FIG. 10 with the male tool hot pressed into the air-laid blank;

FIG. 12 is a cross-sectional view of an illustrative embodiment of the 3D shaped product;

FIGS. 13 and 14 schematically illustrate folding of a 3D shaped product at creases;

FIG. 15 is a flow chart illustrating a method for manufacturing an air-laid blank according to an embodiment;

FIG. 16 is a flow chart illustrating a method for manufacturing an air-laid blank according to another embodiment;

FIG. 17 is a flow chart illustrating a method for manufacturing a folded 3D shaped packaging product according to an embodiment;

FIG. 18 is a flow chart illustrating a method for manufacturing a folded 3D shaped packaging product according to another embodiment; and

FIG. 19 is a flow chart illustrating a method for manufacturing a 3D shaped product.

### DETAILED DESCRIPTION

The present embodiments generally relate to 3D shaped packaging products, and in particular to folded 3D shaped packaging products for cushioning and/or thermal insulation of packaged goods.

Folded 3D shaped packaging products of the present embodiments are useful as environmentally more friendly replacements to corresponding 3D shaped packaging products made of or from foamed polymers, for instance expanded polystyrene (EPS). More sustainable alternatives to polymer products have been proposed in U.S. patent application no. 2010/0190020, European patent no. 1 446 286 no. 2010/0190020, European patent no. 1 446 286 and, which concern hot pressing of porous fiber mats produced by the process called air-laying into 3D structures with matched rigid molds or by membrane molding. The 3D shaped products produced in the above mentioned documents are, however, dense with thin cross sections and have therefore limited shock absorbing or damping ability and comparatively poor thermal insulation. Furthermore, these prior art 3D shaped products have limited capability of protecting multiple sides of a goods for shock absorption or damping and/or thermal insulation. As a consequence, multiple 3D shaped products may be needed to fully enclose and protect a given goods.

The folded 3D shaped packaging products of the present embodiments are formed by hot pressing of an air-laid blank comprising natural fibers and a binder. An air-laid blank, sometimes also referred to as dry-laid blank, air-laid mat, dry-laid mat, air-laid web or dry-laid web, is formed by a process known as air-laying, in which natural fibers and binders are mixed with air to form a porous fiber mixture deposited onto a support and consolidated or bonded by heating or thermoforming. This air-laid blank is characterized by being porous, having the character of an open cell foam and being produced in a so-called dry forming method, i.e., generally without addition of water. The air-laying process was initially described in U.S. Pat. No. 3,575,749. The air-laid blank may be in the form as produced in the air-laying process. Alternatively, the air-laid blank may be in an at least partly processed form, such as by being cut into a given form prior to hot pressing.

According to the present embodiments, folding lines are formed in the air-laid blank or in a 3D shaped product formed by hot pressing of the air-laid blank. This means that the 3D shaped product can be folded to form a folded 3D shaped product that may protect multiple sides of packaged goods and even fully enclose such packaged goods. As a consequence, the packaged goods is more effectively protected against shocks and high or low temperatures as compared to traditional 3D shaped products that may only protect a portion of the packaged goods, thereby requiring multiple 3D shaped products to fully protect the packaged goods. Furthermore, by folding the 3D shaped product around the packaged goods it is possible to protect larger packaged goods that are too large to fit into cavities pressed into 3D shaped products or that can be protected by deep drawn 3D shaped products. Accordingly, the folded 3D shaped products of the present invention have improved shock absorbing and damping effect and/or improved thermal insulation as compared to prior art non-foldable 3D shaped products.

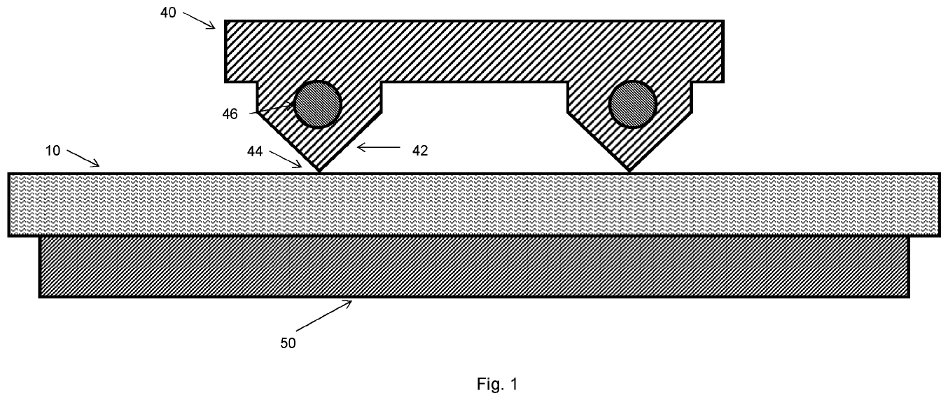

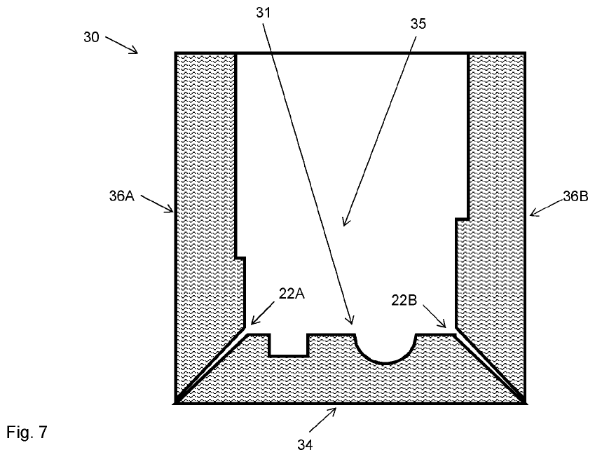

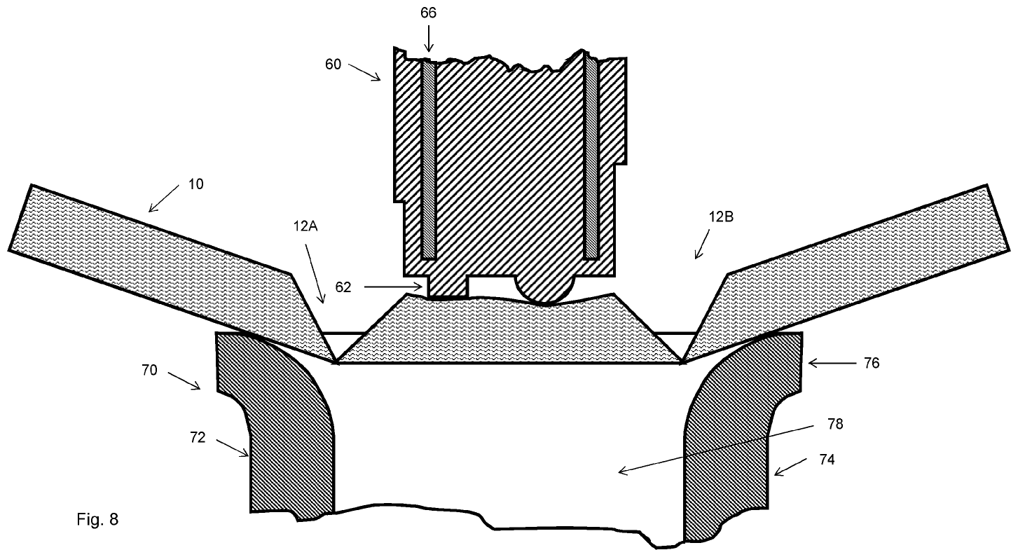

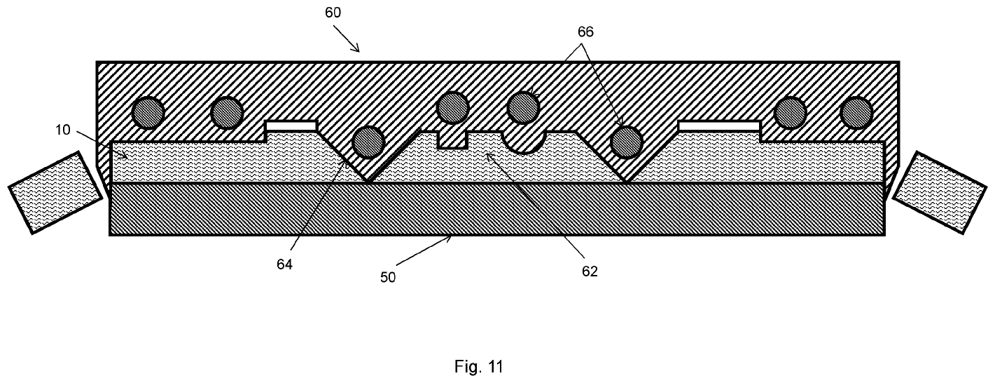

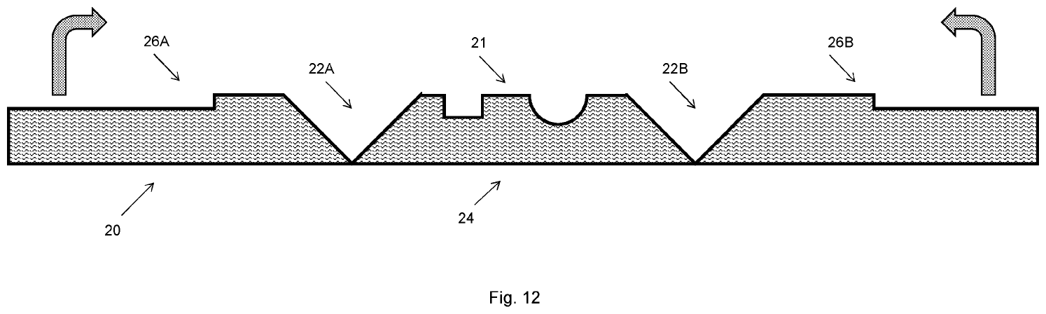

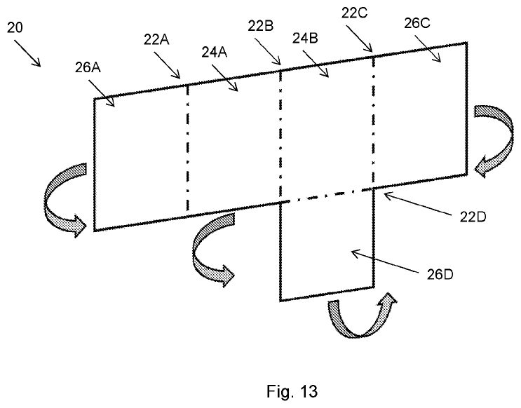

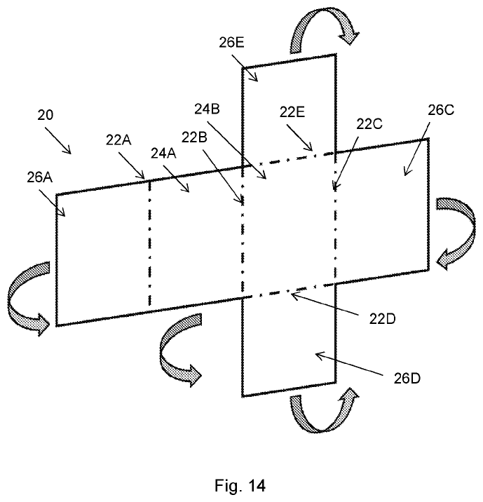

An aspect of the invention relates to an air-laid blank 10, see FIGS. 1 to 6. The air-laid blank 10 comprises natural fibers at a concentration of at least 70% by weight of the air-laid blank 10. The air-laid blank 10 also comprises a thermoplastic polymer binder at a concentration selected within an interval of from 4 up to 30% by weight of the air-laid blank 10. According to the invention, the air-laid blank 10 comprises at least one crease 12A, 12B, 12C, 12D constituting a folding line for folding a 3D shaped product 20, see FIGS. 12-14, into a folded 3D shaped packaging product 30 for cushioning and/or thermal insulation of packaged goods, see FIG. 7. The 3D shaped product 20 is formed by hot pressing of the air-laid blank 10 comprising the at least one crease 12A, 12B, 12C, 12D. Alternatively, the at least one crease 12A, 12B, 12C, 12D of the air-laid blank 10 constitutes a folding line for hot pressing and folding the air-laid blank 10, see FIGS. 8-9, to form a folded 3D shaped packaging product 30 for cushioning and/or thermal insulation of packaged goods.

Hence, the air-laid blank 10 of the present invention comprises at least one crease 12A, 12B, 12C, 12D that constitutes a folding line to fold a 3D shaped product 20 obtained by hot pressing the air-laid blank 10 to get a folded 3D shaped packaging product 30. Alternatively, the folded 3D shaped packaging product 30 is obtained by simultaneously hot pressing and folding, along the at least one crease 12A, 12B, 12C, 12D, the air-laid blank 10. In either case, either first hot pressing and then folding or hot pressing and folding in the same operation, the result is a folded 3D shaped packaging product 30 that is adapted for cushioning and/or thermal insulation of packaged goods.

The at least one crease 12A, 12B, 12C, 12D could be any form of indentation, groove or fold in the air-laid blank 10 that enables folding of the air-laid blank 10 along the crease 12A, 12B, 12C, 12D or folding of the 3D shaped product 20 formed by hot pressing the air-laid blank 10. The at least one crease 12A, 12B, 12C, 12D can have various cross-sectional shapes and dimensions depending on the particular tool used to form the at least one crease 12A, 12B, 12C, 12D in the air-laid blank 10. For instance, the at least one crease 12A, 12B, 12C, 12D could have a V-shaped or wedged cross section, a U-shaped cross section, or a rectangular cross section as illustrative, but non-limiting, examples. If the air-laid blank 10 has multiple, i.e., at least two, creases 12A, 12B, 12C, 12D they could all have the same cross-sectional shape and dimensions. However, it is in fact possible to have different cross-sectional shapes and/or different dimensions of different creases 12A, 12B, 12C, 12D in a single air-laid blank 10.

The at least one crease 12A, 12B, 12C, 12D extends through a portion of the thickness of the air-laid blank 10 but not through the whole thickness of the air-laid blank 10 so that the parts 14, 16A, 16B, 16C, 16D of the air-laid blank 10 are held together.

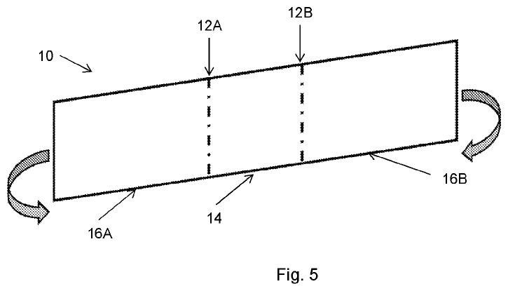

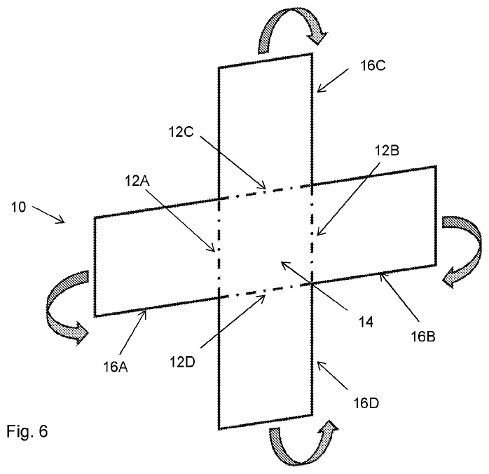

In an embodiment, the air-laid blank 10 comprises at least two creases 12A, 12B, 12C, 12D constituting respective folding lines, see FIGS. 5-6. In such an embodiment, the folded 3D shaped packaging product 30 comprises at least two side walls 36A, 36B and an intermediate section 34, see FIG. 7. The at least two side walls 36A, 36B are angled relative to the intermediate section 34 at a respective angle independently selected within an interval of from 10° up to 170°. In a particular embodiment, the at least two side walls 36A, 36B are angled relative to the intermediate section 34 at a respective angle independently selected within an interval of from 45° up to 135°, preferably within an interval of from 80° is up to 100°, and more preferably about 90°.

FIG. 5 illustrates an example of an air-laid blank 10 according to the invention having two creases 12A, 12B. The air-laid blank 10 could then be regarded as comprising two end parts 16A, 16B with an intermediate part 14. The figure also indicates how the air-laid blank 10 can be folded along the two creases 12A, 12B to, following hot pressing, get a folded 3D shaped packaging product 30 as shown in

FIG. 7. In such a case, the two end parts 16A, 16B correspond to the side walls 36A, 36B of the folded 3D shaped packaging product 30 and the intermediate part 14 corresponds to the intermediate section 34. Such a folded 3D shaped packaging product 30 can be used to enclose a packaged goods and protect three sides of the packaged goods. The folded 3D shaped packaging product 30 then forms a pocket-like structure. Two such folded 3D shaped packaging products 30 could be used in combination to enclose all six sides of packaged goods. However, thick folded 3D shaped packaging products 30 formed from an air-laid blank 10 as shown in FIG. 5 may fully protect three sides of the packaged goods and at least partly protect two of the other sides of the packaged goods if the packaged goods partly extends into cavities in the side walls 36A, 36B of the folded 3D shaped packaging product 30 so that the side walls 36A, 36B at least partly extend around the packaged goods.

FIG. 6 illustrates another embodiment of an air-laid blank 10 according to the invention having four creases 12A, 12B, 12C, 12D. This embodiment of the air-laid blank 10 then has four end parts 16A, 16B, 16C, 16D and an intermediate or central part 14. A folded 3D shaped packaging product 30 produced from such an air-laid blank 10 will, thus, protect five sides of a packaged goods and forms a box-like structure without a lid.

In an embodiment, the natural fibers of the air-laid blank 10 are wood fibers. In a particular embodiment, the natural fibers are cellulose and/or lignocellulose fibers. Hence, in an embodiment, the natural fibers contain cellulose, such as in the form of cellulose and/or lignocellulose, i.e., a mixture of cellulose and lignin. The natural fibers may also contain lignin, such as in the form of lignocellulose. The natural fibers may additionally contain hemicellulose. In a particular embodiment, the natural fibers are cellulose and/or lignocellulose pulp fibers produced by chemical, mechanical and/or chemi-mechanical pulping of softwood and/or hardwood. For instance, the cellulose and/or lignocellulose pulp fibers are in a form selected from the group consisting of sulfate pulp, sulfite pulp, thermomechanical pulp (TMP), high temperature thermomechanical pulp (HTMP), mechanical fiber intended for medium density fiberboard (MDF-fiber), chemi-thermomechanical pulp (CTMP), high temperature chemi-thermomechanical pulp (HTCTMP), and a combination thereof.

The natural fibers can also be produced by other pulping methods and/or from other cellulosic or lignocellulosic raw materials, such as flax, jute, hemp, kenaf, bagasse, cotton, bamboo, straw or rice husk.

The air-laid blank 10 comprises the natural fibers in a concentration of at least 70% by weight of the air-laid blank 10. In a preferred embodiment, the air-laid blank 10 comprises the natural fibers in a concentration of at least 72.5%, more preferably at least 75%, such as at least 77.5%, at least 80%, at least 82.5%, at least 85% by weight of the air-laid blank 10. In some applications, even higher concentrations of the natural fibers may be used, such as at least 87.5%, at least 90%, at least 92.5%, at least 95% or at least 96% by weight of the air-laid blank 10.

The thermoplastic polymer binder is included in the air-laid blank 10 as binder to bind the air-laid blank 10 together and preserve its form and structure during handling and storage. The thermoplastic polymer binder may also assist in building up the foam-like structure of the air-laid blank 10. The thermoplastic polymer binder is intermingled with the natural fibers during the air-laying process forming a fiber mixture. The thermoplastic polymer binder may be added in the form of a powder, but is more often added in the form of fibers that are intermingled with the natural fibers in the air-laying process. Alternatively, or in addition, the thermoplastic polymer binder may be added as solution, emulsion or dispersion into and onto the air-laid blank 10 during the air-laying process. This latter technique is most suitable for thin air-laid blanks 10.

In a particular embodiment, the thermoplastic polymer binder is selected from the group consisting of a thermoplastic polymer powder, thermoplastic polymer fibers and a combination thereof.

In an embodiment, the thermoplastic polymer binder, or at least a portion thereof, has a softening point not exceeding a degradation temperature of the natural fibers. Hence, the thermoplastic polymer binder, or at least a portion thereof, thereby becomes softened at a process temperature during the hot pressing that does not exceed the degradation temperature of the natural fibers. This means that at least a portion of the thermoplastic polymer binder becomes malleable but preferably not melted, which enables hotpressing while maintaining the porous structure of the air-laid blank 10 at least partly in in the folded 3D shaped packaging product 30 and where the hot pressing is performed at a temperature that does not degrade the natural fibers in the air-laid blank 10.

In an embodiment, the thermoplastic polymer binder is or comprises thermoplastic polymer fibers cut a fixed length, which is typically referred to as staple fibers. It is generally preferred for the mixing in the air-laying process and, thereby, for the properties of the formed air-laid blank 10 if the length of the thermoplastic polymer fibers is of the same order of magnitude as the length of the natural fibers or longer. Length of the thermoplastic polymer fibers and the natural fibers as referred to herein is length weighted average fiber length. Length weighted average fiber length is calculated as the sum of individual fiber lengths squared divided by the sum of the individual fiber lengths.

In an embodiment, the thermoplastic polymer binder is or comprises thermoplastic polymer fibers having a length weighted average fiber length that is selected within an interval of from 100 up to 600%, preferably from 125 up to 500%, and more preferably from 150 up to 450% of a length weighted average fiber length of the natural fibers. In a particular embodiment, the thermoplastic polymer binder is or comprises thermoplastic polymer fibers having a length weighted average fiber length that is selected within an interval of from 200 up to 400%, preferably within an interval of from 250 up to 350%of a length weighted average fiber length of the natural fibers. In a particular embodiment, the thermoplastic polymer fibers have a length weighted average fiber length within an interval of from 1 up to 12 mm, such as within an interval of from 1 up to 10 mm, preferably within an interval of from 2 up to 8mm and more preferably within an interval of from 2 up to 6 mm.

The length weighted average fiber length of the natural fibers is dependent on the source of the natural fibers, such as tree species they are derived from, and the pulping process. A typical interval of length weighted average fiber length of natural fibers is from about 0.8 mm up to about 5 mm.

In an embodiment, the thermoplastic polymer binder is or comprises, such as consists of, mono-component and/or bi-component thermoplastic polymer fibers. Bi-component thermoplastic polymer fibers, also known as bico fibers, comprise a core and sheath structure, where the core is made from a first polymer, copolymer and/or polymer mixture and the sheath is made from a second, different polymer, copolymer and/or polymer mixture.

In an embodiment, the thermoplastic polymer binder is or comprises, such as consists of, bi-component polymer fibers comprising a core component made of a material having a melting temperature above a temperature at which the air-laid blank 10 is heated during hot pressing of the air-laid blank 10. The bi-component polymer fibers also comprise a sheath component made of a material having a melting temperature below the temperature at which the air-laid blank 10 is heated during hot pressing of the air-laid blank 10.

In this embodiment, the core component of the bi-component polymer fibers has a melting temperature that is higher than the melting temperature of the sheath component of the bi-component polymer fibers. In addition, the melting temperature of the core component is above the process temperature at which the air-laid blank is heated during the hot pressing, whereas the melting temperature of the sheath component is below this process temperature. This means that the core component will not melt but advantageously becomes malleable during the hot pressing, whereas the sheath component will melt or at least be significantly tackified. The sheath component will thereby adhere to natural fibers while the non-melted but malleable core component provides structural support. Such bi-component polymer fibers achieve both good attachment to the natural fibers and simultaneously maintaining the porous structure of the air-laid blank even during hot pressing.

In an embodiment, the thermoplastic polymer binder is or comprises, such as consists of, mono-component thermoplastic polymer fibers made from i) a material selected from the group consisting of polyethylene (PE), ethylene acrylic acid copolymer (EAA), ethylene-vinyl acetate (EVA), polypropylene (PP), polystyrene (PS), polybutylene adipate terephthalate (PBAT), polybutylene succinate (PBS), polylactic acid (PLA), polyethylene terephthalate (PET), polycaprolactone (PCL), copolymers thereof and mixtures thereof, and ii) optionally one or more additives.

Hence, in an embodiment, the thermoplastic polymer fibers are made of a material selected from the above mentioned group. In another embodiment, the thermoplastic polymer fibers are made of a material selected from the above mentioned group and one or more additives.

In another embodiment, the thermoplastic polymer binder is or comprises, such as consists of, bi-component thermoplastic polymer fibers having a core and/or sheath made from i) a material or materials selected from the group consisting of PE, EM, EVA, PP, PS, PBAT, PBS, PLA, PET, PCL, copolymers thereof and mixtures thereof, and ii) optionally one or more additives. In a further embodiment, the thermoplastic polymer binder is or comprises, such as consists of, a combination or mixture of mono-component thermoplastic polymer fibers made from i) a material selected from the group consisting of PE, EAA, EVA, PP, PS, PBAT, PBS, PLA, PET, PCL, copolymers thereof and mixtures thereof, and ii) optionally one or more additives, and bi-component thermoplastic polymer fibers having a core and/or sheath made from i) a material or materials selected from the group consisting of PE, EM, EVA, PP, PS, PBAT, PBS, PLA, PET, PCL, copolymers thereof and mixtures thereof, and ii) optionally one or more additives.

The thermoplastic polymer binder could be made of a single type of thermoplastic polymer fibers, i.e., made of a same material in the case of mono-component thermoplastic polymer fibers or made of the same material or materials in the case of bi-component thermoplastic polymer fibers. However, it is also possible to use a thermoplastic polymer binder made of one or multiple, i.e., at least two, different mono-component thermoplastic polymer fibers made of different materials and/or one or multiple different bi-component thermoplastic polymer fibers made of different materials.

In an embodiment, the thermoplastic polymer binder is or comprises a thermoplastic polymer powder made of i) a material selected from the group consisting of PE, EM, EVA, PP, PS, PBAT, PBS, PLA, PET, PCL, copolymers thereof and mixtures thereof, and ii) optionally one or more additives.

It is also, as mentioned in the foregoing, possible to use a thermoplastic polymer binder that is a combination of thermoplastic polymer fibers and thermoplastic polymer powder.

Generally, air-laid blanks and folded 3D shaped packaging products made there from can be recycled if they can be disintegrated in an opener for this specific purpose and run through the air-laying process again with the possible addition of additional binder. This is in reality only possible for edge trim and other process rejects that are recycled in-house within the production facility. For consumers and other end users, this is not an option since there is no air-laying process in existing recycling schemes. A much better option would be if the products produced by or from air-laying could be sorted into one of the existing recycling fractions, for which there are already functioning collection and recycling systems. Since the majority of the material is made up of wood fibers that could go into a paper or board making process these would be the natural, existing, fractions to collect the air-laid blanks and 3D shaped packaging products with. With printing papers sensitive to impurities that can cause faults in the printing process or dark specs in the paper, the board fraction would typically be the better option. Recycled board is often used for mid-plies in box boards with several layers or fluting in corrugated board. These are less sensitive to impurities, even those that decrease the strength of the recycled material.

A prerequisite for a material to be recyclable as board is that it is repulpable i.e., that most of it will disintegrate into separate fibers when sheared with water in a repulping process and, thus, pass the following screening to give a good yield of usable pulp. The conventional thermoplastic fiber binders used is for air-laid blanks attach too well to the cellulose and/or lignocellulose fibers. Hence, these thermoplastic fibers prevent disintegration to a degree that makes the yield of the repulping process far too low to be economically useful.

The thermoplastic polymer binders with high tackiness and low melting points that are often used for mono-component fibers and the sheath of bi-component fibers present an additional problem in board recycling. These may turn into stickies and render the material classified as unsuitable for recycling in the repulping process. One way to solve both these problems would be to use a binder that will dissolve in the water of the repulping process i.e., is water soluble at the repulping temperature. At the same time the binder would need to be thermoplastic with a melting point that does not exceed the degradation temperature of the natural fibers and it should have a very good adhesion to the natural fibers after being heated and cooled again. Furthermore, the binder should not have detrimental effects in the board-making process. It is also an advantage if they are safe to use in food contact applications.

“Repulpability” and “recyclability” in paper or board processes are most widely tested using the PTS-method PTS-RH 021/97 from the German Papiertechnische Stiftung. For board products, the PTS-method tests the recyclability in two steps, where the first is a repulpability test. In the repulpability test, 50 g of material is disintegrated in a standard disintegrator for a 20 min at conditions as specified in PTS-method PTS-RH 021/97. The undispersed residue is screened out and its weight is determined. If the weight of this undispersed residue corresponds to less than 20% of the original weight (50 g), the material is classified as “recyclable”. If the weight of the undispersed residue is 20-50% of the original weight, the material is classified as “recyclable but worthy of product design improvement”. The second part of the PRS-method PTS-RH 021/97 for board products is a test for impurities, especially substances that become extremely tacky when heated, in the test to 130° C. In the board making process, such sticky or tacky substances can attach to machine fabrics and other essential part of the board machine and cause runability problems and the need for extended, costly, cleaning stoppages. In the paper and board industry, this type of impurities is usually called “stickies”. The presence of such stickies in the unscreened, disintegrated sample render the material classified as “non-recyclable due to stickies”. The presence of other impurities can restrict the usability of the recycled pulp acquired from the material but is not considered totally detrimental.

Hence, in an embodiment, the thermoplastic polymer binder, or at least parts thereof, is water soluble at a repulping temperature selected for repulping the air-laid blank 10. In such a case, the air-laid blank 10 and the folded 3D shaped packaging product 30 made therefrom could be recycled in a repulping process as mentioned.

Water soluble as used herein implies that the thermoplastic polymer binder dissolves or disperses in water during the repulping process. For instance, the thermoplastic polymer binder may dissolve or disperse in water at the repulping temperature of the repulping process, i.e., forms a solution or colloidal dispersion, in which the thermoplastic polymer binder exists as single molecules and/or form colloidal aggregates. Water soluble as used herein implies, in an embodiment, a solubility of more than 0.5 g thermoplastic polymer binder per 100 ml water, preferably at least 1 g thermoplastic polymer binder per 100 ml water, and more preferably at least 5 g thermoplastic polymer binder per 100 ml water, such as at least 10 g thermoplastic polymer binder per 100 ml water. Hence, in an embodiment, the at least a part of the thermoplastic polymer binder that is water soluble preferably has water solubility in accordance with above.

Examples of such water soluble thermoplastic polymer materials are polyvinyl alcohol (PVA), polyethylene glycol (PEG), poly(2-ethyl-2-oxazoline) (PEOX), polyvinyl ether (PVE), polyvinylpyrrolidone (PVP), polyacrylic acid (PAA), polymethacrylic acid (PMAA), copolymers thereof and mixtures thereof.

In an embodiment, the thermoplastic polymer binder is or comprises, such as consists of, mono-component thermoplastic polymer fibers made from i) a material selected from the group consisting of PVA, PEG, PEOX, PVE, PVP, PAA, PMAA, copolymers thereof and mixtures thereof, and ii) optionally one or more additives. In another embodiment, the thermoplastic polymer binder is or comprises, such as consists of, bi-component thermoplastic polymer fibers having a sheath or a sheath and core made from i) a material or materials selected from the group consisting of PVA, PEG, PEOX, PVE, PVP, PAA, PMAA, copolymers thereof and mixtures thereof, and ii) optionally one or more additives. In a particular embodiment, at least the sheath of the bi-component thermoplastic polymer fibers is made from i) a material selected from the group consisting of PVA, PEG, PEOX, PVE, PVP, PAA, PMAA, copolymers thereof and mixtures thereof, and ii) optionally one or more additives. In such a particular embodiment, also the core of the bi-component thermoplastic polymer fibers could be selected from this group. However, if the core of the bi-component thermoplastic polymer fibers does not soften to become tacky and attach to the natural fibers in the hot pressing the core may actually be made of fibers that are not necessarily water soluble at the repulping temperature. This means that the core could be made of the previously mentioned thermoplastic polymer materials. Hence, in this particular embodiment, the bi-component thermoplastic polymer fibers comprise a core component made from i) a material selected from the group consisting of polyethylene PE, EM, EVA, PP, PS, PBAT, PBS, PLA, PET, PCL, copolymers thereof and mixtures thereof, and ii) optionally one or more additives, and a sheath component made from i) a material selected from the group consisting of PVA, PEG, PEOX, PVE, PVP, PAA, PMAA, copolymers thereof and mixtures thereof, and ii) optionally one or more additives. In a further embodiment, the thermoplastic polymer binder is or comprises, such as consists of, a combination of mono-component polymer fibers made from i) a material selected from the group consisting of PVA, PEG, PEOX, PVE, PVP, PM, PMAA, copolymers thereof and mixtures thereof, and ii) optionally one or more additives, and bi-component polymer fibers having a core and/or sheath made from i) a material or materials selected from the group consisting of PVA, PEG, PEOX, PVE, PVP, PM, PMAA, copolymers thereof and mixtures thereof, and ii) optionally one or more additives.

In an embodiment, the thermoplastic polymer binder is or comprises a thermoplastic polymer powder made of i) a material selected from the group consisting of PVA, PEG, PEOX, PVE, PVP, PAA, PMAA, copolymers thereof and mixtures thereof, and ii) optionally one or more additives.

In a particular embodiment, the air-laid blank 10 and preferably the folded 3D shaped packaging product 30 are repulpable or recyclable preferably as defined according to the PTS-method PTS-RH 021/97 from the German Papiertechnische Stiftung. Hence, in a particular embodiment, the air-laid blank 10 and preferably the folded 3D shaped packaging product 30 results in less than 50% (w/w), preferably less than 20% (w/w) of undispersed residue following disintegration of 50 g of the air-laid blank 10 or folded 3D shaped packaging product 30 in a standard disintegrator for a 20 min at conditions as specified in PTS-method PTS-RH 021/97.

The repulping temperature used in the repulping process is typically within the range of from 20 to 100° C., such as within the range of from 30 to 90° C., and typically within the range of from 30 to 70° C. Hence, in an embodiment, at least a part of the thermoplastic polymer binder is water soluble at a temperature selected within an interval of from 20 to 100° C., preferably within an interval of from 30 to 90° C., and more preferably within an interval of from 30 to 70° C. In a particular embodiment, the temperature of water used in the repulping process is about 40° C. in accordance with the PTS-method PTS-RH 021/97. Hence, in an embodiment, at least a part of the thermoplastic polymer binder is water soluble at 40° C.

Briefly, the PTS-method PTS-RH 021/97 comprises disintegrating the specimens in line with DIN EN ISO 5263-1:2004-12, but using tap water of 40° C. The dilution water is poured over the sample material, which are placed in the disintegrator (Standard disintegrator to DIN EN ISO 5263-1:2004-12) without pre-is swelling. The sample material is disintegrated at a consistency of 2.5% o.d. corresponding to a weighed-in amount of 50 g o.d. and a slurry volume of 2 l. The disintegration period is 20 min (60,000 revolutions). After disintegrating, the pulp (total stock) is completely transferred to a standard distributor (Standard distributor to ZELLCHEMING Technical Information Sheet ZM V/6/61) and diluted with tap water to a total volume of 10 l, which corresponds to 0.5% consistency. The screening is conducted in line with ZELLCHEMING Technical Information Sheet ZM V/18/62 using a perforated plate of 0.7 mm hole diameter. The test device is set to the “low stroke” mode. A test portion of the slurry corresponding to 2 g o.d. (400 ml) is taken out of the distributor and diluted to a total volume of 1000 ml, which is filled into the fractionator during 30 s and screened for 5 min at a washing water pressure of 0.3 bar. After 5 min, the water supply and the membrane displacement motor are cut off. The valve on the retaining ring is opened to drain the water, which has gathered below the test chamber. The locking screw is loosened and the test chamber is tilted upwards. The rear nozzles are covered with one hand to prevent water from dripping onto the unprotected perforated plate with the residue on it. The residue from the perforated plate is washed into a 2 l tank and dewatered through a filter inserted in a Büchner funnel. The filter is folded once and placed in the dryer to dry at 105° C. up to weight constancy. Products are rated as “recyclable” if the disintegration residue does not exceed 20% in relation to the input and rated as “recyclable, but worthy of product design improvement” if the disintegration residue is from 20% to 50% of the input.

In an embodiment, the air-laid blank 10 comprises the thermoplastic polymer binder at a concentration selected within an interval of from 10 up to 30%, such as from 15 up to 30% by weight of the air-laid blank 10. In a particular embodiment, the air-laid blank 10 comprises more than 15% but no more than 30% by weight of the thermoplastic polymer binder. For instance, the air-laid blank 10 comprises the thermoplastic polymer binder at a concentration selected within an interval of from 15 or 17.5 up to 30% by weight of the air-laid blank 10. In a particular embodiment, the air-laid blank 10 comprises the thermoplastic polymer binder at a concentration selected within an interval of from 15 or 17.5 up to 25%, such as from 20 up to 25% by weight of the air-laid blank 10.

In some applications, it may advantageous to have a comparatively higher concentration of the thermoplastic polymer binder, such as more than 15% by weight of the air-laid blank 10, in order to preserve the integrity and foam-like structure of the air-laid blank 10 even when pressing the air-laid blank 10 at a lower pressure to get a porous 3D shaped product 20. Thus, if too low concentration of the thermoplastic polymer binder is included, i.e., below 4% by weight of the air-laid blank 10, the formed 3D shaped product 20 may unintentionally disintegrate or fall apart since the combination of too low concentration of the thermoplastic polymer binder and a “soft” hot pressing of the air-laid blank 10 is not sufficient to keep the structure of the 3D shaped product 20.

In some embodiments, the air-laid blank 10 comprises the thermoplastic polymer binder at a concentration selected within an interval of from 4 up to 15% by weight of the air-laid blank 10, preferably within an interval of from 5 up to 15% by weight of the air-laid blank 10, such as within an interval of from 7.5 up to 15% by weight of the air-laid blank 10, and more preferably within an interval of from 10 up to 15% by weight of the air-laid blank 10.

In an embodiment, the density of the folded 3D shaped packaging product 30 and of the 3D shaped product 20 is equal to or less than four times the density of the air-laid blank 10. In a particular embodiment, the density of the folded 3D shaped packaging product 30 and of the 3D shaped product 20 is equal to or less than three times the density of the air-laid blank 10, preferably equal to or less than twice the density of the air-laid blank 10.

In a particular embodiment, the density of the air-laid blank 10 as referred to herein is, preferably, the density of the air-laid blank 10 prior to forming the at least one crease 12A, 12B, 12C, 12D in the air-laid blank 10.

The folded 3D shaped packaging product 30 is, in an embodiment, produced from the air-laid blank 10 in a hot pressing process that preserves at least some of the porosity of the air-laid blank 10. Hence, the density of the folded 3D shaped packaging product 30 is less than four times the density of the air-laid blank 10. The prior art hot pressing processes that produce dense 3D shaped packaging products with thin cross sections typically increase the density of the 3D shaped packaging products with several tens of the density of the air-laid blank, such as 10 to 50 times. The significant increase in density of the prior art 3D shaped packaging products means that most of the porosity of the air-laid blank is lost resulting in a dense and compact fiber structure. The comparatively lower increase in density according this embodiment in clear contrast preserves the porous structure of the air-laid blank 10 also in the folded 3D shaped packaging product 30.

The density of the folded 3D shaped packaging product 30 as used herein is the average or mean density of the folded 3D shaped packaging product 30. This means that folded 3D shaped packaging product 30 may contain portions or parts with different porosity and thereby different densities. This is due to hot pressing different part of the air-laid blank 10 at different levels or amounts due to the shape of a male tool 60 employed in the hot pressing, see FIGS. 8-11. The density of the folded 3D shaped packaging product 30 is, however, the average or mean density rather than densities of different parts thereof, and represents the total mass of the folded 3D shaped packaging product 30 divided by the volume of the 3D shaped packaging product 30 excluding any cavities in the folded 3D shaped packaging product 30 formed during the hot pressing by the male tool 60 and/or a female tool 70, see FIGS. 8-9, and/or during folding of the 3D shaped product 20, see FIG. 12.

In a particular embodiment, the hot pressing of the air-laid blank 10 preferably leads to an increase in density of the folded 3D shaped packaging product 30 as compared to the density of the air-laid blank 10 of no more than 300%, preferably no more than 250%, and more preferably no more than 200%, 150% or most preferably of no more than 100%.

The hot pressing, however, preferably causes an increase in the density of the 3D shaped product 20 as compared to the density of the air-laid blank 10 due to hot pressing of the male tool 60 or the male tool 60 and the female tool 70 into the air-laid blank 10. The increase in density caused by the hot pressing is preferably at least 5%, such as at least 7.5%, at least 10%, at least 12.5%, at least 15%, at least 17.5%, at least 20%, at least 22.5%, at least 25%, or even higher, such as at least 30%, at least 40%, at least 50%, at least 60%, at least 70%, at least 80%, at least 90% or at least 100%.

In various embodiments, the increase in density caused by the hot pressing is at least 12.5% but no more than 300%, such as at least 15% but no more than 275%, at least 17.5% but no more than 250%, at least 20% but no more than 225%, such as least 22.5% but no more than 200%. In a particular embodiment, no part of the 3D shaped product 20 formed by hot pressing of the air-laid blank 10 has a high density. Hence, the cushioning and/or thermal insulation properties are preferably achieved for all parts of the 3D shaped product 20. In an embodiment, no part of the 3D shaped product has a density that is more than ten times, preferably more than nine times, such as more than eight times, seven times, six times, or five times, and more preferably more than four times, such as three times, or twice, the average density of the air-laid blank 10.

Hot pressing as used herein indicates that the air-laid blank 10 is exposed to pressure exerted by pressing a male tool 60 or a male tool 60 and a female tool 70 into the air-laid blank 10, or pressing the male tool 60 and the female tool 70 with the air-laid blank 10 placed there between, while the air-laid blank 10 is heated or exposed to heat. Hence, hot pressing implies that the pressing is done at a temperature above room temperature, preferably at a temperature at which the thermoplastic polymer binder, or at least a portion thereof, is malleable. Hot pressing using heated tools 60, 70 and/or heated air-laid blanks 10 is further described herein in connection with FIGS. 17 to 19.

In an embodiment, the density of the air-laid blank 10 is selected within an interval of from 10 to 60 kg/m³.

In an embodiment, the density of the 3D shaped product 20 and the folded 3D shaped packaging product 30 is selected within an interval of from 15 to 240 kg/m₃. In a preferred embodiment, the density of the 3D shaped product 20 and the folded 3D shaped packaging product 30 is selected within an interval of from 15 to 200 kg/m₃, preferably within an interval of from 15 to 150 kg/m³ and more preferably within an interval of from 15 to 100 kg/m³. In a particular embodiment, the density of the 3D shaped product 20 and the folded 3D shaped packaging product 30 is selected within an interval of from 20 to 75 kg/m³, preferably within an interval of from 25 to 70 kg/m³, and more preferably within an interval of from 25 to 65 kg/m³.

In an embodiment, the air-laid blank 10 has a thickness of at least 10 mm, preferably at least 20 mm, and more preferably at least 30 mm, such as at least 40 mm, or even thicker, such as at least 50 mm, at least 60 mm, at least 70 mm, at least 80 mm or at least 90 mm. In a particular embodiment, the air-laid blank 10 has a thickness of at least 100 mm, such as at least 150 mm, at least 200 mm, or at least 250 mm. It is also possible to have very thick air-laid blanks 10 having a thickness of at least 300 mm. Hence, in such an embodiment, rather thick air-laid blanks 10 are used to obtain folded 3D shaped packaging products 30 suitable for cushioning and/or thermal insulation even after hot pressing. The thickness of the air-laid blank 10 may be selected based on the particular use of the resulting folded 3D shaped packing product 30, such as based on the cushioning and/or isolation requirements for the folded 3D shaped packaging product 30 and/or based on the geometries of the packaged goods that are to be protected by the folded 3D shaped packaging product 30.

Correspondingly, the folded 3D shaped packing product 30 and/or the 3D shaped product 20 could have a wall thickness of at least 10 mm, preferably at least 15 mm, such as at least 20 mm or at least 25 mm, and more preferably at least 30 mm, such as at least 35 mm, or at least 40 mm, or even thicker, such as at least 45 mm or at least 50 mm. In an embodiment, a low average pressure, preferably equal to or below 200 kPa, is used when hot pressing the air-laid blank 10 into the 3D shaped product 20 or the folded 3D shaped packaging product 30. This low average pressure preserves a significant portion of the is thickness of the air-laid blank 10. The hot pressing of the air-laid blank 10 may, as is further described herein, compress different portions of the air-laid blank 10 differently hard. Hence, some portions of the 3D shaped product 20 or the folded 3D shaped packaging product 30 may have a thickness that is substantially the same or merely slightly less than the thickness of the air-laid blank 10. In a particular embodiment, at least those portions of the folded 3D shaped packaging product 30 that will be in contact with the goods to be protected preferably have the above mentioned thicknesses.

In an embodiment, the folded 3D shaped packaging product 30 is configured to protect the packaged goods from electrostatic discharge (ESD). In such an embodiment, the air-laid blank 10 is electrically conducting or semiconducting. For instance, the air-laid blank 10 could comprise an electrically conducting polymer or electrically conducting fibers to make the air-laid blank 10 and, thereby, the folded 3D shaped packaging product 30 formed by hot pressing the air-laid blank 10 electrically conducting or semiconducting. In such a case, the air laid blank 10 preferably comprises the electrically conducting polymer or fibers at a concentration of no more than 10% by weight of the air-laid blank 10, and more preferably of no more than 5% by weight of the air-laid blank 10. In an embodiment, a portion of the natural fibers may be replaced with electrically conducting polymer or fibers. In another embodiment, the binder is made of, or comprises, an electrically conducting polymer. In a further embodiment, these two embodiments are combined. In a particular embodiment, the electrically conducting polymer or fibers are carbon fibers. Instead of, or as a complement to, having electrically conducting polymers or fibers, the air-laid blank 10 could comprise an electrically conducting or semiconducting fillers, such as carbon black, which, for instance, could be in the form of an additive to the binder.

The air-laid blank 10 may, thus, comprise one or more additives in addition to the natural fibers and the thermoplastic polymer binder. One or more additives could be added to the thermoplastic polymer binder and/or added when producing the thermoplastic polymer binder. Alternatively, or in addition, one or more additives could be added to the natural fibers. Alternatively, or in addition, one or more additives could be added to the natural fibers and the thermoplastic polymer binder, such as during the air-laying process.

Illustrative, but non-limiting, examples of such additives include electrically conducting or semiconducting fillers, coupling agents, flame retardants, dyes, impact modifiers, etc.

Another aspect of the embodiments relates to a method for manufacturing an air-laid blank 10, see FIGS. 1-4 and 15. The air-laid blank 10 comprises natural fibers at a concentration of at least 70% by weight of the air-laid blank 10 and a thermoplastic polymer binder at a concentration selected within an interval of from 4 up to 30% by weight of the air-laid blank 10. The method comprises pressing, in step S1, a die 40 with at least one bar 42 into the air-laid blank 10 to form at least one crease 12A, 12B, 12C, 12D. The at least one crease 12A, 12B, 12C, 12D constitutes a folding line for folding a 3D shaped product 20 into a folded 3D shaped packaging product 30 for cushioning and/or thermal insulation of packaged goods. The 3D shaped product 20 is formed by hot pressing of the air-laid blank 10 comprising the at least one crease 12A, 12B, 12C, 12D. Alternatively, the at least one crease 12A, 12B, 12C, 12D constitutes a folding line for hot pressing and folding the air-laid blank 10 comprising the at least one crease 12A, 12B, 12C, 12D to form the folded 3D shaped packaging product 30 for cushioning and/or thermal insulation of packaged goods.

The shape of the at least one bar 42 of the die 40 defines, as mentioned above, the cross-sectional shape(s) and dimension(s) of the at least one crease 12A, 12B, 12C, 12D in the air-laid blank 10. For instance, the at least one bar 42 could have a pointed cross section, a V-shaped or wedge-shaped cross section, a U-shaped cross section, or a rectangular cross section as illustrative, but non-limiting, examples. The tip 44 of the at least one bar 42 is, in an embodiment, a rounded tip 44. Such a rounded tip 44 presses down into rather than cuts through a portion of the thickness of the air-laid blank 10 and thereby results in at least one crease 12A, 12B, 12C, 12D that is more suitable for folding as compared to having a sharp tip.

The die 40 with the at least one bar 42 is pressed into the air-laid blank 10 to form the at least one crease 12A, 12B, 12C, 12D in step S1. In this operation step S1, the at least one bar 42 is preferably pressed into but not through the air-laid blank 10 to thereby reduce the risk of unintentionally cutting the air-laid blank 10 in two rather than forming the at least one folding line.

The die 40 may comprise a single bar 42 or multiple bars 42. In a preferred embodiment, the die 40 comprises one bar 42 per crease 12A, 12B, 12C, 12D to be formed in the air-laid blank 10.

In an embodiment, step S1 comprises pressing a heated die 40 with the at least one bar 42 into the air-laid blank 10. Heating of the die 40, or rather the at least one bar 42, causes softening of the thermoplastic polymer binder in the portion(s) of the air-laid blank 10 engaged by the at least one bar 42. This softening of the thermoplastic polymer binder implies that the formed at least one crease 12A, 12B, 12C, 12D remains indented in the air-laid blank 10 after cooling even when handling the air-laid blank 10 up to and following hot pressing.

In an embodiment, the die 40 comprise heating elements 46 that are preferably controllable heating elements 46 to heat the die 40, or rather the at least one die 42, to a desired temperature. The temperature of the die 40 typically depends on the type of natural fibers and thermoplastic polymer binder in the air-laid blank 10 and the cycle time of the pressing in step S1. In a particular embodiment, the heated die 40 is preferably heated to a temperature selected within an interval of from 120° C. up to 210° C., preferably within an interval of from 120° C. up to 190° C. At these temperatures, many thermoplastic polymer binders are in a malleable but not melted state.

The air-laid blank 10 is preferably positioned on a base platen 50 when pressing the at least one bar 42 25 of the die 40 into the air-laid blank 10 as shown in FIGS. 1 to 4. In an embodiment, the base platen 50 is at ambient temperature. In another embodiment, the base platen 50, or at least a portion thereof, is heated. For instance, the base platen 50 could be divided into different portions or zones, of which at least one is heated whereas remaining(s) portion(s) or zone(s) is(are) not heated, or different portions or zones of the base platen 50 may be heated at different temperatures. In a particular embodiment, 30 portion(s) or zone(s) of the base platen 50 aligned with the at least one bar 42 of the die 40 is(are) preferably heated or is(are) preferably heated to a higher temperature than remaining portions or zones of the base platen 50.

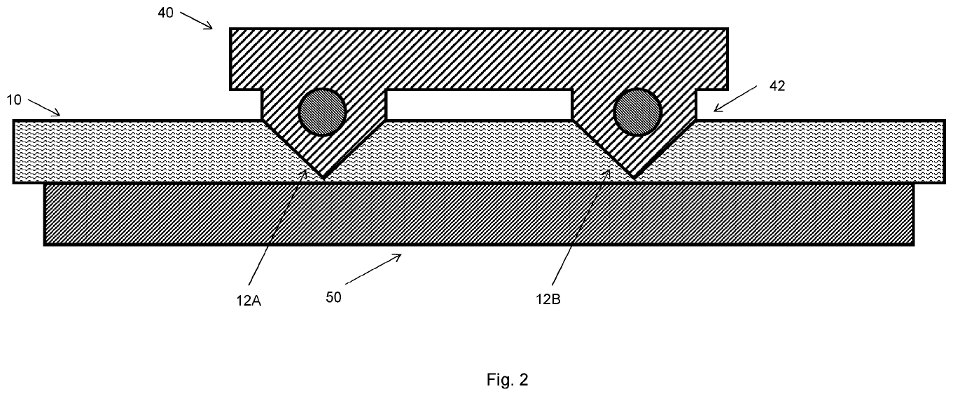

In FIGS. 1 and 2, the air-laid blank 10 may be in a pre-cut form, i.e., have already been cut into a desired shape, such as by a saw, a cutter, or stamping die. Alternatively, any such cutting operation may be performed after the pressing operation in step S1.

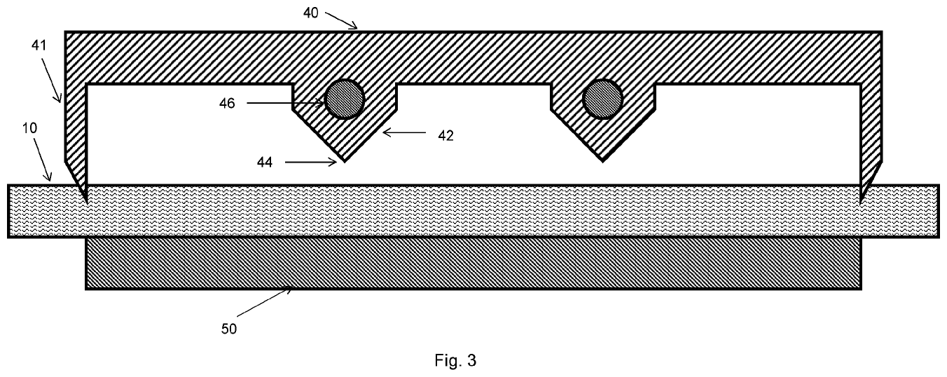

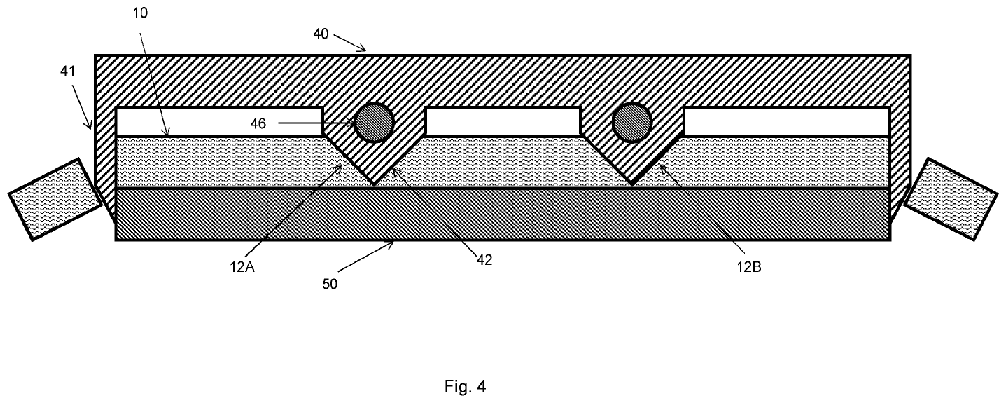

FIGS. 3 and 4 illustrate an alternative embodiment. In this embodiment, the die 40 comprises at least one cutter 41 configured to cut at least a portion of the air-laid blank 10, preferably simultaneously with pressing the at least one bar 42 into the air-laid blank 10. Hence, in this embodiment, the cutting of the air-laid blank 10 and the formation of the at least one crease 12A, 12B, 120, 12D are preferably performed in the same pressing operation in step S1 and using the same tool, i.e., the die 40 comprising both at least one bar 42 and at least one cutter 41.

FIG. 16 is a flow chart illustrating another embodiment of a method for manufacturing an air-laid blank 10 comprising natural fibers at a concentration of at least 70% by weight of the air-laid blank 10 and a thermoplastic polymer binder at a concentration selected within an interval of from 4 up to 30% by weight of the air-laid blank 10. This method comprises sawing or cutting, in step S10, at least one crease 12A, 12B, 12C, 12D in the air-laid blank 10. The at least one crease 12A, 12B, 12C, 12D constitutes a folding line for folding a 3D shaped product 20 into a folded 3D shaped packaging product 30 for cushioning and/or thermal insulation of packaged goods. The 3D shaped product 20 is formed by hot pressing of the air-laid blank 10 comprising the at least one crease 12A, 12B, 12C, 12D. Alternatively, the at least one crease 12A, 12B, 12C, 12D constitutes a folding line for hot pressing and folding the air-laid blank 10 comprising the at least one crease 12A, 12B, 12C, 12D to form the folded 3D shaped packaging product 30 for cushioning and/or thermal insulation of packaged goods.

Hence, in this embodiment, the at least one crease 12A, 12B, 12C, 12D is formed in the air-laid blank 10 by sawing or cutting through a portion of the thickness but not through the whole of the thickness of the air-laid blank 10. The shape and dimensions of the at least one crease 12A, 12B, 12C, 12D are then defined by the tool, such as saw or cutter, used in step S10.

The tool used in step S10, such as saw or cutter, may be at ambient temperature or may be heated, such as heated to a temperature within an interval of from 120° C. up to 210° C., preferably within an interval of from 120° C. up to 190° C.

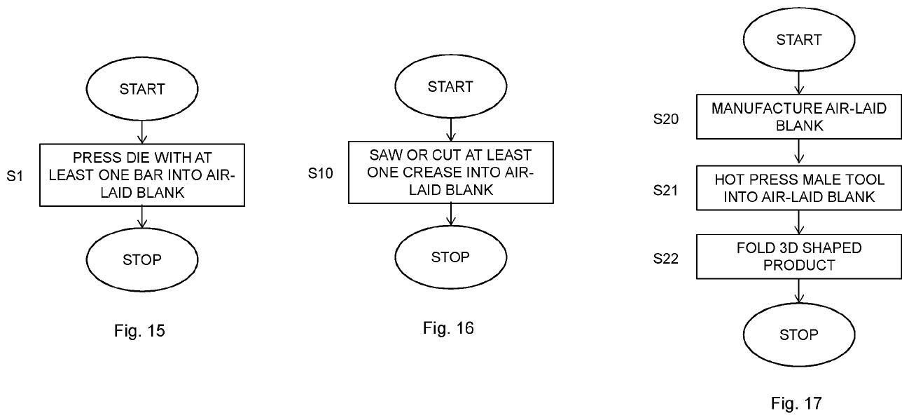

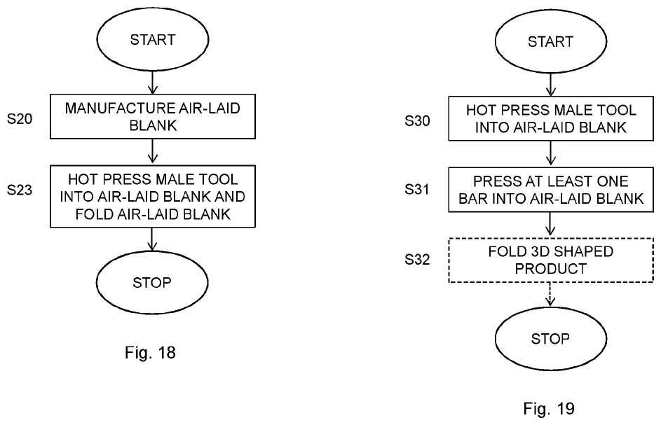

A further aspect of the invention relates to a method for manufacturing a folded 3D shaped packaging product 30, see FIGS. 8, 9, 17 and 18. The method comprises manufacturing, in step S20, an air-laid blank 10 according to the invention, such as described above in connection with FIG. 15 or 16. In an embodiment, the method comprises the two additional steps S21 and S22 as shown in FIG. 17. Step S21 comprises hot pressing of a male tool 60 into the air-laid blank 10 comprising at least one crease 12A, 12B, 12C, 12D to form a 3D shaped product 20 comprising at least one crease 22A, 22B, 22C, 22D, 22E and having a 3D shape at least partly defined by the male tool 60. The method also comprises folding, in step S22, the 3D shaped product 20 at the at least one crease 22A, 22B, 22C, 22D, 22E to form the folded 3D shaped packaging product 30 for cushioning and/or thermal insulation of packaged goods. In another embodiment, the method comprises the additional step S23 as shown in FIG. 18, see also FIGS. 8 and 9. Step S23 comprises hot pressing of a male tool 60 into the air-laid blank 10 comprising at least one crease 12A, 12B, 12C, 12D and positioned on a female tool 70 folding the air-laid blank 10 at the at least one crease 12A, 12B, 12C, 12D to form the folded 3D shaped packaging product 30 for cushioning and/or thermal insulation of packaged goods. In this embodiment, the folded 3D shaped packaging product 30 has a 3D shape at least partly defined by the male tool 60 and the female tool 70.

In the embodiment shown in FIG. 17, the hot pressing and the folding are performed as two separate operations or method steps. In the first step S21, the male tool 60 is hot pressed into the air-laid blank comprising the at least one crease 12A, 12B, 12C, 12D to form a 3D shaped product 20 comprising at least one crease 22A, 22B, 22C, 22D, 22E as schematically shown in the cross-sectional view of FIG. 12. In this cross-sectional view, the 3D shaped product 20 comprises two creases 22A, 22B constituting folding lines, two end parts 26A, 26B and an intermediate part 24. The male tool 60 produces a 3D structure 21 when pressed into the air-laid blank 10. Hence, the 3D shaped product 20 has a 3D shape as indicated by 21 at least partly defined by the male tool 60.

The air-laid blank 10 is preferably positioned on a base platen 50 during the hot pressing in step S21.

The 3D shaped product 20 as formed in step S21 in FIG. 17 is then folded, in step S22 and as indicated by the arrows in FIG. 12, along the creases 22A, 22B to form a folded 3D shaped packaging product 30. In the cross-sectional view of FIG. 7, the folded 3D shaped packaging product 30 has a pocket-like structure with two side walls 36A, 36B, corresponding to the end parts 26A, 26B of the 3D shaped product 20, and an intermediate section 34, corresponding to the intermediate part 24 of the 3D shaped product 20. The folded 3D shaped packaging product 30 defines a cavity 35 and at least a portion 31 of the inner surface of the folded 3D shaped packaging product 30 has a 3D shape defined by the male tool 60 and adapted to the shape of the packaged goods to be protected by the folded 3D shaped packaging product 30. The folded 3D shaped packaging product 30 as shown in FIG. 7 may have more than two side walls 36A, 36B, such as two, three or four side walls, of which only two are shown in FIG. 7.

In the embodiment shown in FIG. 18, the hot pressing and folding are performed at least partly simultaneously. The air-laid blank 10 with the at least one crease 12A, 12B, 12C, 12D is then positioned on a female tool 70 rather than a base platen 50. The male tool 60 is then hot pressed into the air-laid blank 10 to produce a 3D shape in at least a portion of the air-laid blank 10. Accordingly, the male tool 60 comprises at least one structure 62 to be hot pressed into the air-laid blank 10 to produce a 3D structure 31 in the air-laid blank 10 and the resulting folded 3D shaped packaging product 30. Hot pressing the male tool 60 into the air-laid blank 10 not only creates a 3D structure in the air-laid blank 10 but also pushes the air-laid blank 10 into the female tool 70 as shown in FIG. 8. The air-laid blank 10 is then folded along the at least one crease 12A, 12B, 12C, 12D. In step S23, the inner shape and geometry of the resulting folded 3D shaped packaging product 30 is defined by the male tool 60, whereas the outer shape and geometry of the folded 3D shaped packaging product 30 is defined by the female tool 70. In this operation, the end parts 16A, 16B of the air-laid blank 10 are folded up and pressed against the sides of the male tool 60 to define side walls 36A, 36B of the cavity 35. The bottom of the cavity 35, i.e., the intermediate section 34 in FIG. 7, is simultaneously defined by the downward pressing action of the male tool 60.

The method described above and shown in FIGS. 7, 8, 9, 17 and 18 can be used to produce folded 3D shaped packaging products 30 having more than two side walls 36A, 36B, such as three or four side walls.

25 In an embodiment, the female tool 70 has a cavity 78 having a depth larger than a height of side walls 36A, 36B of the folded 3D shaped packaging product 30. Hence, the side walls 72, 74 of the female tool 70 are preferably higher than the side walls 36A, 36B of the folded 3D shaped packaging product 30. In such an embodiment, the air-laid blank 10 will be fully pressed into the female tool 70 acting as a mold by the hot pressing action of the male tool 60 as shown in FIG. 9. As a consequence of being fully pressed into the female tool 70, the resulting folded 3D shaped packaging product 30 generally has a more well-defined overall structure as compared to if parts of the original air-laid blank 10 would protrude outside of the female tool 70 and thereby would not be pressed between the male tool 60 and the female tool 70.

In an embodiment, a rim 76 of the female tool 70 is curved outward to guide the air-laid blank 10 comprising at least one crease 12A, 12B, 12C, 12D into a cavity 78 of the female tool 70, see FIG. 8. Such a curved rim 76 simplifies the folding of the air-laid blank 10 at the least one crease 12A, 12B, 12C, 12D when the male tool 60 presses the air-laid blank 10 into the cavity 78 of the female tool 70.

In an embodiment, step S21 in FIG. 17 comprises hot pressing of a heated male tool 60 into the air-laid blank 10. In this embodiment, the heated male tool 60 is preferably heated to a temperature selected within an interval of from 120° C. up to 210° C., preferably within an interval of from 120° C. up to 190° C. Hence, in this embodiment, the heating of the air-laid blank 10 is achieved by usage of a heated male tool 60. The male tool 60 may then comprise heating elements 66 that are preferably controllable heating elements 66 to heat the male tool 60 to a desired temperature for hot pressing. The temperature of the male tool 60 typically depends on the type of natural fibers and thermoplastic polymer binders in the air-laid blank 10 and the cycle time of the hot pressing in step S21. However, the above presented interval is suitable for most combinations of natural fibers, thermoplastic polymer binders and cycle times.

In an embodiment, the air-laid blank 10 is positioned on base platen 50. In an embodiment, step S21 in FIG. 17 comprises hot pressing of the heated male tool 60 into the air-laid blank 10 positioned on a base platen 50 having a temperature equal to or below ambient temperature.

In this embodiment, the heating of the air-laid blank 10 is achieved by the male tool 60, whereas the base platen 50 is at ambient temperature, typically room temperature, or may even be cooled. Having a base platen 50 at ambient temperature or even cooled may reduce the risk of heating the air-laid blank 10 too much during the hot pressing in step S21, which otherwise may have negative consequences of degrading the natural fibers, melting the thermoplastic polymer binder and destroying the porous structure of the air-laid blank 10 and the formed 3D shaped product 20.

It is, though, possible to have the air-laid blank 10 positioned on a heated base platen 50 during the hot pressing in step S21 even in combination with a heated male tool 60. In such a case, the surface of the air-laid blank 10 resting on the heated base platen 50 could be heat sealed during the hot pressing in step S21.

In a corresponding embodiment, step S23 in FIG. 18 comprises hot pressing of a heated male tool 60 into the air-laid blank 10 positioned on the female tool 70. The above presented temperature intervals are also suitable for the heated male tool 60 in this embodiment.

In an embodiment, step S23 comprises hot pressing of the heated male tool 60 into the air-laid blank 10 positioned on a heated female tool 70. In a particular embodiment, the heated female tool 70 is preferably heated to a temperature selected within an interval of from 120° C. up to 210° C., preferably within an interval of from 120° C. up to 190° C. In such a case, the surfaces of the air-laid blank 10 facing the heated male tool 60 and the heated female tool 70 could be heat sealed during the hot pressing in step S23.

In an embodiment, both the male tool 60 and the female tool 70 are heated, preferably to a temperature selected within an interval of from 120° C. up to 210° C., preferably within an interval of from 120° C. up to 190° C. The male tool 60 and the female 70 may be heated to the same or different temperatures. In another embodiment, one of the male tool 60 and the female tool 70 is heated, while the other is at ambient temperature or even cooled.

In the above presented embodiments, at least one of the tools 60, 70 used in the hot pressing in step S21 or S23 is heated. In another embodiment, at least a portion of the air-laid blank 10 is heated prior to hot pressing, in step S21 or S23, of the male tool 60 into the air-laid blank 10.

Hence, rather than heating the male tool 60 and/or any female tool 70, the air-laid blank 10 is heated, preferably prior to the hot pressing operation. The air-laid blank 10 is then preferably heated to a temperature where the thermoplastic polymer binder, or at least a portion thereof, is in a malleable but not melted state. For most thermoplastic polymer binders this temperature is within an interval of from 80° C. up to 180° C., such as from 100° C. up to 180° C. or from 120° C. up to 160° C. Hence, in an embodiment, the air-laid blank 10 is preferably heated to a temperature within the interval of from 80° C. up to 180° C.

In this embodiment, the male tool 60 and the base platen 50 or female tool 70 may independently be at ambient temperature, such as room temperature, or cooled.

In an embodiment, heating of the air-laid blank 10 could be combined with usage of a heated male tool 60 or a male tool 60 and a female tool 70, of which at least one is heated.

A further aspect of the invention relates to a folded 3D shaped packaging product 30 for cushioning and/or thermal insulation of packaged goods. The folded 3D shaped packaging product 30 is folded at at least one crease 22A, 22B, 22C, 22D, 22E constituting a folding line in a 3D shaped product 20 formed by hot pressing of an air-laid blank 10 comprising natural fibers at a concentration of at least 70% by weight of the air-laid blank 10 and a thermoplastic polymer binder at a concentration selected within an interval of from 4 up to 30% by weight of the air-laid blank 10.

In an embodiment, the folded 3D shaped packaging product 30 comprises at least two side walls 36A, 36B and an intermediate section 34. The at least two side walls 36A, 36B are angled relative to the intermediate section 34 at a respective angle independently selected within an interval of from 10° up to 170°, preferably within an interval of from 45° up to 135°, and more preferably within an interval of from 80° up to 100°, such as 90°.

Yet another aspect of the invention relates to a 3D shaped product 20. The 3D shaped product 20 is formed by hot pressing of an air-laid blank 10 comprising natural fibers at a concentration of at least 70% by weight of the air-laid blank 10 and a thermoplastic polymer binder at a concentration selected within an interval of from 4 up to 30% by weight of the air-laid blank 10. The 3D shaped product 20 comprises at least one crease 22A, 22B, 22C, 22D, 22E constituting a folding line for folding the 3D shaped product 20 into a folded 3D shaped packaging product 30 for cushioning and/or thermal insulation of packaged goods.

In an embodiment, each of the 3D shaped product 20 and the folded 3D shaped packaging product 30 has a density that is equal to or is less than four times a density of the air-laid blank 10. In a particular embodiment, each of the 3D shaped product 20 and the folded shaped packaging product 30 has a density that is equal to or less than three times the density of the air-laid blank 10, and preferably equal to or less than twice the density of the air-laid blank 10.

Preferred embodiments regarding the densities and thicknesses of the folded 3D shaped packaging product 30 and the 3D shaped product 20 are presented in the foregoing.

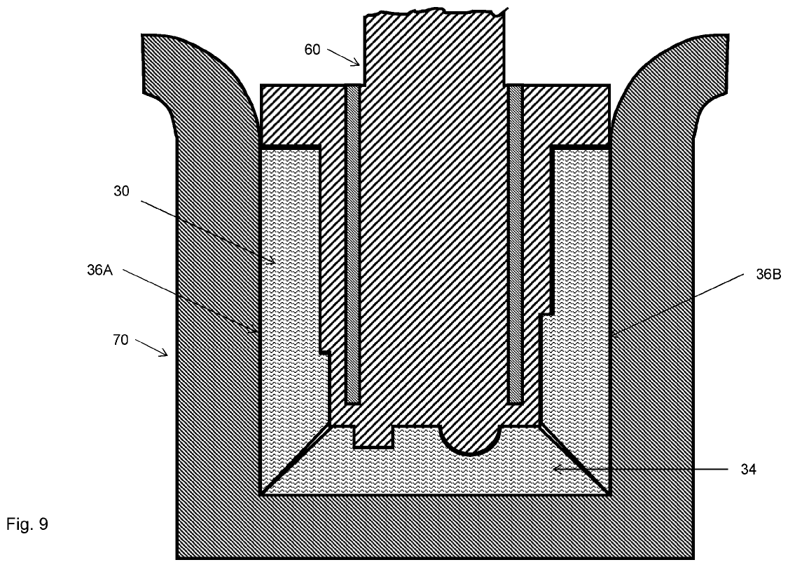

Another aspect of the invention relates to a method for manufacturing a 3D shaped product 20, see FIGS. 10-12 and 19. The method comprises hot pressing, in step S30, of a male tool 60 into an air-laid blank 10 comprising natural fibers at a concentration of at least 70% by weight of the air-laid blank 10 and a thermoplastic polymer binder at a concentration selected within an interval of from 4 up to 30% by weight of the air-laid blank 10 to form the 3D shaped product 20 having a 3D shape at least partly defined by the male tool 60. The method also comprises pressing, in step S31 and simultaneously with step S30, at least one bar 64 into the air-laid blank 10 to form at last one crease 22A, 22B, 22C, 22D, 22E constituting a folding line for folding the 3D shaped product 20 into a folded 3D shaped packaging product 30 for cushioning and/or thermal insulation of packaged goods.

Hence, in this embodiment, an air-laid blank 10 lacking any creases is used as starting material for the manufacturing method in FIG. 19. The air-laid blank 10 is then hot pressed simultaneously as at least one bar 64 is pressed into the air-laid blank 10 to form the at least one crease 22A, 22B, 22C, 22D, 22E.

The 3D shaped product 20 as formed following steps S30 and S31 can then be folded along the at least one crease 22A, 22B, 22C, 22D, 22E in step S32 to obtain the folded 3D shaped packaging product 30.

A 3D shaped product 20 with at least one crease 22A, 22B, 22C, 22D, 22E and that can be folded into a folded 3D shaped packaging product 30 has several advantages as compared to, for instance, hot pressing and folding an air-laid blank 10 comprising at least one crease 12A, 12B, 12C, 12D to directly get a folded 3D shaped packaging product 30. For instance, more complex folded 3D shaped packaging products 30 could be produced by separating the hot pressing and the folding operations as compared to hot pressing and folding in the same operation as shown in FIGS. 8 and 9. Hence, the method as shown in FIG. 19 enables larger flexibility in geometries and shapes of the final folded 3D shaped packaging product 30. Furthermore, there is generally less waste during the manufacturing process as shown in FIG. 19. Yet another advantage is that the 3D shaped product 20 is substantially flat and can thereby be effectively stored and/or transported while occupying limited space and be folded to a more space demanding folded 3D shaped packaging product 30 first in connection with packaging of goods.

In an embodiment, steps S30 and S31 are performed simultaneously as one method step. Such a method step then comprises pressing the male tool 60 comprising the at least one bar 64 into the air-laid blank 10 simultaneously with hot pressing of the male tool 60 into the air-laid blank 10. Hence, in this embodiment, the male tool 60 both comprises at least one structure 62 for creating a 3D structure in the air-laid blank 10 and at least one bar 64 for creating the at least one crease 22A, 22B, 22C, 22D, 22E in the resulting 3D shaped product 20.

It may also be possible to use two different tools in the method shown in FIG. 19, i.e., a male tool 60 and a separate die with at least one bar, which are both preferably substantially simultaneously pressed down into the air-laid blank 10.

The disclosure above of the at least one bar 42 of the die 40 in FIGS. 1 to 4 applies mutatis mutandis to the at least one bar 64 of the male tool 60, including design of the at least one bar 64, design of the tip of the least one bar 64 and heating of the at least one bar 64.

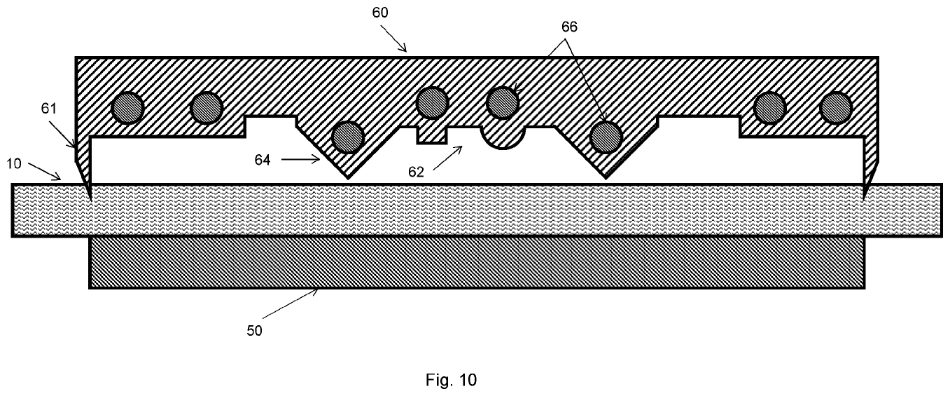

The male tool 60 can comprise at least one cutter 61 shown in FIGS. 10 and 11. This at least one cutter 61 then operates in a similar way to the at least one cutter 41 of the die 40 in FIGS. 3 and 4. In another embodiment, the male tool 60 does not comprise any cutters.

In an embodiment, step S30 comprises hot pressing of a heated male tool 60 into the air-laid blank 10. The heated male tool 60 is then preferably heated to a temperature selected within an interval of from 120° C. up to 210° C., preferably within an interval of from 120° C. up to 190° C.

In an embodiment, step S30 comprises hot pressing of the heated male tool 60 into the air-laid blank 10 positioned on a base platen 50 having a temperature equal to or below ambient temperature, or a heated base platen 50.

In an embodiment, a comparatively low pressure is used during the hot processing of the air-laid blank to preserve at least a portion of the porosity of the air-laid blank 10 also in the 3D shaped product 20 and the folded 3D shaped packaging product 30. In such an embodiment, the air-laid blank 10 is preferably hot pressed in steps S21, S23, and S30 at an average pressure equal to or below 200 kPa, such as equal to or below 175 kPa, or preferably equal to or below 150 kPa. In an embodiment, the average pressure is defined as the applied force dived by the area of the air-laid blank 10 during hot pressing.

In some applications, it may be desirable to seal some or all of the surfaces of the folded 3D shaped packaging product 30 and/or 3D shaped product 20, such as by heat, to prevent linting from the surface(s) onto the packaged goods. Surfaces that are processed with heat in the hot pressing will be sealed and do not need any additional (heat) sealing. The at least one surface to be sealed can be sealed, such as by heat, before or after the hot pressing operation. Hence, in an embodiment, the folded 3D shaped packaging product 30 and/or 3D shaped product 20 comprises at least one surface that is heat sealed to inhibit linting from the at least one surface.

In some applications, the folded 3D shaped packaging product 30 and/or the 3D shaped product 20, or at least a portion thereof, can be laminated with a surface layer, such as a thermoplastic polymer film or non-woven textile. This can both prevent linting and add additional functions to the surface, such as moisture barriers, haptic properties, color and designs. The film or non-woven could be made by any common thermoplastic polymer. Examples include the previously mentioned thermoplastic polymer materials for usage as binders. This layer could be heat laminated to the air-laid blank 10, the folded 3D shaped packaging product 30 and/or the 3D shaped product 20 and/or applied directly, such as by extrusion, onto the air-laid blank 10 and/or 3D shaped product 20. In an embodiment, the film laminated to at least one surface, or a portion thereof, of the folded 3D shaped packaging product 30 and/or 3D shaped product 20 is electrically conducting or semiconducting to provide ESD protection of the packaged goods.

Hence, in an embodiment, the folded 3D shaped packaging product 30 and/or 3D shaped product 20 comprises at least one surface coated with a surface layer selected from the groups consisting of a linting is inhibiting layer, a moisture barrier layer, a haptic layer and a colored layer.

The film, textile or surface layer may be attached to the air-laid blank 10, the folded 3D shaped packaging product 30 or the 3D shaped product 20 by help of a thin layer of a hotmelt glue, by an additional adhesive film or by its own having become semi-melted and sticky during the heat lamination process. This operation can be performed before, after or simultaneously with the hot pressing operation. If the lamination is performed on at least one surface of the air-laid blank 10, which is later to be processed by hot pressing, the softening point of the surface laminate should not exceed the degradation temperature of the natural fibers of the air-laid blank 10. Any hot pressing operation performed after providing a surface layer should preferably be performed at a temperature where the surface layer is in a semi-melted or malleable state but not in a melted stage. If the hot pressing is conducted at a too high temperature at which the surface layer is in a melted stage, the surface layer might delaminate from the surface and the natural fibers may in addition start to degrade if the temperature exceeds their degradation temperature(s).

In an embodiment, the surface layer is attached to the at least one surface of the 3D shaped product 20 by a hotmelt glue and/or by an adhesive film.

In further embodiments, it is possible to apply the surface layer by spraying it onto surface(s) of the folded 3D shaped packaging product 30 and/or 3D shaped product 20. The layer may then contain any substances that can be prepared as solutions, emulsions or dispersions, such as thermoplastic polymers; natural polymers, such as starch, agar, guar gum or locust bean gum, microfibrillar or nanofibrillar cellulose or lignocellulose or mixtures thereof. The surface layer may in addition comprise other substances, such as emulsifying agents, stabilizing agents, electrically conductive agents, etc. that provide additional functionalities to the surface layer and the folded 3D shaped packaging product 30.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible.

1. An air-laid blank comprising:
natural fibers at a concentration of at least 70% by weight of the air-laid blank; and
a thermoplastic polymer binder at a concentration selected within an interval of from 4 up to 30% by weight of the air-laid blank, wherein
the air-laid blank further comprises at least one crease constituting a folding line for
i) folding a three-dimensional (3D ) shaped product into a folded 3D shaped packaging product for cushioning, or thermal insulation, or both of packaged goods, wherein the 3D shaped product is formed by hot pressing of the air-laid blank comprising the at least one crease; or
ii) hot pressing and folding the air-laid blank comprising the at least one crease to form a folded three-dimensional (3D ) shaped packaging product for cushioning, or thermal insulation, or both of packaged goods.

2. The air-laid blank according to claim 1, wherein
the air-laid blank comprises at least two creases constituting respective folding lines; and
the folded 3D shaped packing product comprising at least two side walls and an intermediate section, wherein the at least two side walls are angled relative to the intermediate section at a respective angle independently selected within an interval of from 10° up to 170°.

3. The air-laid blank according to claim 1, wherein the natural fibers are wood fibers.

4. The air-laid blank according to claim 3, wherein the natural fibers are selected from a group consisting of: sulfate pulp, sulfite pulp, thermomechanical pulp (TMP), high temperature thermomechanical pulp (HTMP), mechanical fiber intended for medium density fiberboard (MDF-fiber), chemi-thermomechanical pulp (CTMP), high temperature chemi-thermomechanical pulp (HTCTMP), and a combination thereof

5. The air-laid blank according to claim 1, wherein the air-laid blank comprises the thermoplastic polymer binder at a concentration selected within an interval of from 15 up to 30% by weight of the air-laid blank.

6. The air-laid blank according to claim 1, wherein the thermoplastic polymer binder, or at least a portion thereof, has a softening point not exceeding a degradation temperature of the natural fibers.

7. The air-laid blank according to claim 1, wherein the thermoplastic polymer binder comprises bi-component polymer fibers comprising:
a core component made of a material having a melting temperature above a temperature at which the air-laid blank is heated during hot pressing of the air-laid blank; and
a sheath component made of a material having a melting temperature below the temperature at which the air-laid blank is heated during hot pressing of the air-laid blank.

8. The air-laid blank according to claim 1, wherein the thermoplastic polymer binder comprises mono-component thermoplastic polymer fibers, or bi-component thermoplastic polymer fibers, or both, made from i) a material selected from group consisting of polyethylene (PE), ethylene acrylic acid copolymer (EAA), ethylene-vinyl acetate (EVA), polypropylene (PP), polystyrene (PS), polybutylene adipate terephthalate (PBAT), polybutylene succinate (PBS), polylactic acid (PLA), polyethylene terephthalate (PET), polycaprolactone (PCL), copolymers thereof and mixtures thereof, and ii) optionally one or more additives.

9. The air-laid blank according to claim 1, wherein at least a portion of the thermoplastic polymer binder is water soluble at a repulping temperature selected for repulping the air-laid blank.

10. The air-laid blank according to claim 1, wherein the thermoplastic polymer binder comprises mono-component thermoplastic polymer fibers, or bi-component thermoplastic polymer fibers, or both made from i) a material or materials selected from a group consisting of:
polyvinyl alcohol (PVA), polyethylene glycol (PEG), poly(2-ethyl-2-oxazoline) (PEOX), polyvinyl ether (PVE), polyvinylpyrrolidone (PVP), polyacrylic acid (PAA), polymethacrylic acid (PMAA), copolymers thereof and mixtures thereof, and ii) optionally one or more additives.

11. The air-laid blank according to claim 1, wherein the thermoplastic polymer binder is or comprises bi-component thermoplastic polymer fibers comprising:
a core component made from i) a material selected from a group consisting of:
polyethylene (PE), ethylene acrylic acid copolymer (EAA), ethylene-vinyl acetate (EVA), polypropylene (PP), polystyrene (PS), polybutylene adipate terephthalate (PBAT), polybutylene succinate (PBS), polylactic acid (PLA), polyethylene terephthalate (PET), polycaprolactone (PCL) , copolymers thereof and mixtures thereof, and ii) optionally one or more additives; and
a sheath component made from i) a material selected from a group consisting of polyvinyl alcohol (PVA), polyethylene glycol (PEG), poly(2-ethyl-2-oxazoline) (PEOX), polyvinyl ether (PVE), polyvinylpyrrolidone (PVP), polyacrylic acid (PAA), polymethacrylic acid (PMAA), copolymers thereof and mixtures thereof, and ii) optionally one or more additives.

12. The air-laid blank according to claim 1, wherein a density of the air-laid blank is within an interval of from 10 to 60 kg/m³.

13. The air-laid blank according to claim 1, wherein the air-laid blank has a thickness of at least 10 mm.

14. (canceled)

15. (canceled)

16. (canceled)

17. (canceled)

18. (canceled)

19. (canceled)

20. (canceled)

21. (canceled)

22. (canceled)

23. A folded three-dimensional (3D ) shaped packaging product for cushioning, or thermal insulation, or both of packaged goods, wherein the folded 3D shaped packaging product is folded at at least one crease constituting a folding line in a 3D shaped product formed by hot pressing of an air-laid blank comprising natural fibers at a concentration of at least 70% by weight of the air-laid blank and a thermoplastic polymer binder at a concentration selected within an interval of from 4 up to 30% by weight of the air-laid blank.

24. The folded 3D shaped packaging product according to claim 23, comprising:
at least two side walls; and
an intermediate section, wherein the at least two side walls are angled relative to the intermediate section at a respective angle independently selected within an interval of from 10° up to 170°.

25. A three-dimensional (3D ) shaped product, wherein
the 3D shaped product is formed by hot pressing of an air-laid blank comprising natural fibers at a concentration of at least 70% by weight of the air-laid blank and a thermoplastic polymer binder at a concentration selected within an interval of from 4 up to 30% by weight of the air-laid blank; and
the 3D shaped product comprises at least one crease constituting a folding line for folding the 3D shaped product into a folded 3D shaped packaging product for cushioning, or thermal insulation, or both of packaged goods.

26. The product according to claim 25, wherein each of the 3D shaped product and the folded shaped packaging product has a density that is equal to or less than four times a density of the air-laid blank.

27. The product according to claim 25, wherein a density of each of the 3D shaped product and the folded 3D shaped packaging product is within an interval of from 15 to 240 kg/m³.

28. The product according to claim 25, wherein the natural fibers are wood fibers.

29. The product according to claim 28, wherein the natural fibers are selected from a group consisting of sulfate pulp, sulfite pulp, thermomechanical pulp (TMP), high temperature thermomechanical pulp (HTMP), mechanical fiber intended for medium density fiberboard (MDF-fiber), chemi-thermomechanical pulp (CTMP), high temperature chemi-thermomechanical pulp (HTCTMP), and a combination thereof

30. The product according to claim 25, wherein the thermoplastic polymer binder, or at least a portion thereof, has a softening point not exceeding a degradation temperature of the natural fibers.

31. The product according to claim 25, wherein the thermoplastic polymer binder comprises bi-component polymer fibers comprising:
a core component made of a material having a melting temperature above a temperature at which the air-laid blank is heated during hot pressing of the air-laid blank; and
a sheath component made of a material having a melting temperature below the temperature at which the air-laid blank is heated during hot pressing of the air-laid blank.

32. The product according to claim 25, wherein the thermoplastic polymer binder is or comprises mono-component thermoplastic polymer fibers or bi-component thermoplastic polymer fibers or both made from i) a material selected from a group consisting of polyethylene (PE), ethylene acrylic acid copolymer (EAA), ethylene-vinyl acetate (EVA), polypropylene (PP), polystyrene (PS), polybutylene adipate terephthalate (PBAT), polybutylene succinate (PBS), polylactic acid (PLA), polyethylene terephthalate (PET), polycaprolactone (PCL), copolymers thereof and mixtures thereof, and ii) optionally one or more additives.

33. The product according to claim 25, wherein at least a part of the thermoplastic polymer binder is water soluble at a repulping temperature selected for repulping the folded 3D shaped packaging product.

34. The product according to claim 25, wherein the thermoplastic polymer binder is or comprises mono-component thermoplastic polymer fibers or bi-component thermoplastic polymer fibers, or both made from i) a material selected from a group consisting of polyvinyl alcohol (PVA), polyethylene glycol (PEG), poly(2-ethyl-2-oxazoline) (PEOX), polyvinyl ether (PVE), polyvinylpyrrolidone (PVP), polyacrylic acid (PAA), polymethacrylic acid (PMAA), copolymers thereof and mixtures thereof, and ii) optionally one or more additives.

35. The product according to claim 25, wherein the thermoplastic polymer binder comprises bi-component thermoplastic polymer fibers comprising:
a core component made from i) a material selected from a group consisting of polyethylene (PE), ethylene acrylic acid copolymer (EAA), ethylene-vinyl acetate (EVA), polypropylene (PP), polystyrene (PS), polybutylene adipate terephthalate (PBAT), polybutylene succinate (PBS), polylactic acid (PLA), polyethylene terephthalate (PET), polycaprolactone (PCL), copolymers thereof and mixtures thereof, and ii) optionally one or more additives; and
a sheath component made from i) a material selected from a group consisting of polyvinyl alcohol (PVA), polyethylene glycol (PEG), poly(2-ethyl-2-oxazoline) (PEOX), polyvinyl ether (PVE), polyvinylpyrrolidone (PVP), polyacrylic acid (PAA), polymethacrylic acid (PMAA), copolymers thereof and mixtures thereof, and ii) optionally one or more additives.

36. (canceled)

37. (canceled)

38. (canceled)

39. (canceled)

40. (canceled)
